(19) United States
(12) Patent Application Publication
(10) Pub. No.: US 2014/0167896 A1
(43) Pub. Date: Jun. 19, 2014

(54) COUPLED INDUCTOR

(71) Applicant: INDUSTRIAL TECHNOLOGY RESEARCH INSTITUDE, (US)

(72) Inventors: Mean-Jue Tung, Kinmen County (TW); Wen-Song Ko, Hsinchu (TW); Yu-Ting Huang, Hsinchu County (TW)

(73) Assignee: INDUSTRIAL TECHNOLOGY RESEARCH INSTITUTE, Hsinchu (TW)

(21) Appl. No.: 13/875,963

(22) Filed: May 2, 2013

(30) Foreign Application Priority Data
Dec. 19, 2012 (TW) 101148454

(51) Int. Cl. H01F 38/14

(52) U.S. Cl. CPC H01F 38/14
USPC 336/5

(57) ABSTRACT

A coupled inductor includes a magnetic core, a first and a second coil. The magnetic core has a top and a bottom surface. The first coil, located in the magnetic core, has a first coil input end and a first coil output end, and is wound around a first axis in a first winding direction from the first coil input end and extended to the first coil output end. The second coil, located in the magnetic core, has a second coil input end and a second coil output end, and is wound around a second axis in a second winding direction, opposite to the first winding direction, from the second coil input end and extended to the second coil output end. An orthographic projection of the first coil on the top surface is at least partially overlapped with that of the second coil on the top surface.

### CROSS-REFERENCE TO RELATED APPLICATIONS

This non-provisional application claims priority under 35 U.S.C. §119(a) on Patent Application No(s). 101148454 filed in Taiwan, R.O.C. on Dec. 19, 2012, the entire contents of which are hereby incorporated by reference.

### TECHNICAL FIELD

The disclosure relates to an inductor, and in particular, to a coupled inductor.

### BACKGROUND

Electronic products are becoming light, thin, short, small and multifunctional, and currently, central processors, graphics processors and many other chips are supplied by a power supply with low-voltage and high-current. With such demand, power inductors are also being developed to be smaller in size and applicable to a multiphase power supply. Therefore, Multiphase coupled inductors were developed. In a conventional technology, a multiphase electrical transformer is provided, which includes a circuit and an inductor. The inductor is fitted (namely, matches) with the circuit and has different winding and connection manners. In the inductor, two coils are wound at a ring-shaped magnetic core. The secondary winding of the inductor is used to be coupled with inductors of other phases, and the secondary windings are connected in series to form a circuit. In another conventional technology, the magnetic core is designed to be ladder-shaped so as to reduce the length of winding, and further reduce the resistance of the winding. In still conventional technology, the magnetic core is divided into a first end magnetic core and a second end magnetic core. An M-winding connects the magnetic cores at two ends, forming an air gap, thereby solving the problem of the leakage inductance. In the above-mentioned technology, the block size of the magnetic core material is emphasized to shorten the winding and reduce the winding resistance, or is emphasized to form an air gap in the inductor, so as to improve the leakage inductance. However, how to improve or maintain the inductance under a large current is not mentioned.

A common coupled inductor includes a magnetic material, and copper wires are wound on the magnetic material to form a coil. When the current in the coil increases, the magnetic field in the magnetic material increases, correspondingly. However, when the magnetic field increases, the current also increases until the magnetic field of the magnetic material is saturated, the inductance decreases dramatically, leading to insufficient storage of the electric energy of the inductor on the circuit. Therefore, it is necessary to design a novel coupled inductor structure to solve the problem brought about by the increase of the current.

### SUMMARY

A coupled inductor according to an embodiment of the disclosure comprises a magnetic core, a first coil and a second coil. The magnetic core has a top surface and a bottom surface, and the top surface and a bottom surface opposite to each other. The first coil is located in the magnetic core and has a first coil input end and a first coil output end. The first coil is wound around a first axis in a first winding direction. The first coil is wound from the first coil input end and is extended to the first coil output end. The first axis passes through the top surface and the bottom surface. The second coil is located in the magnetic core and separated from the first coil. The second coil has a second coil input end and a second coil output end. The second coil is wound around a second axis in a second winding direction. The second coil is wound from the second coil input end and is extended to the second coil output end. The second axis passes through the top surface and the bottom surface. The first winding direction is opposite to the second winding direction. An orthographic projection of the first coil on the top surface is at least partially overlapped with an orthographic projection of the second coil on the top surface.

### BRIEF DESCRIPTION OF THE DRAWINGS

The disclosure will become more fully understood from the detailed description given herein below for illustration only, thus does not limit the disclosure, wherein:

FIG. 1 is a schematic view of a coupled inductor according to one embodiment of the disclosure;

FIG. 2 is an exploded view of a coupled inductor according to one embodiment of the disclosure;

FIG. 3 is a schematic view of a four-phase coupled inductor according to one embodiment of the disclosure;

FIG. 4 is a schematic view of a test device for a coupled inductor according to one embodiment of the disclosure;

FIG. 5A is a view of a large-current inductance test on a reverse coupled inductor with the magnetic permeability being 250 according to a first embodiment of the disclosure;

FIG. 5B is a view of a large-current inductance test on a concurrent coupled inductor with the magnetic permeability being 250 in a comparison embodiment according to a first embodiment of the disclosure;

FIG. 6A is a view of a large-current inductance test on a reverse coupled inductor with the magnetic permeability being 400 according to a first embodiment of the disclosure; and

FIG. 6B is a view of a large-current inductance test on a concurrent coupled inductor with the magnetic permeability being 400 according to a first embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

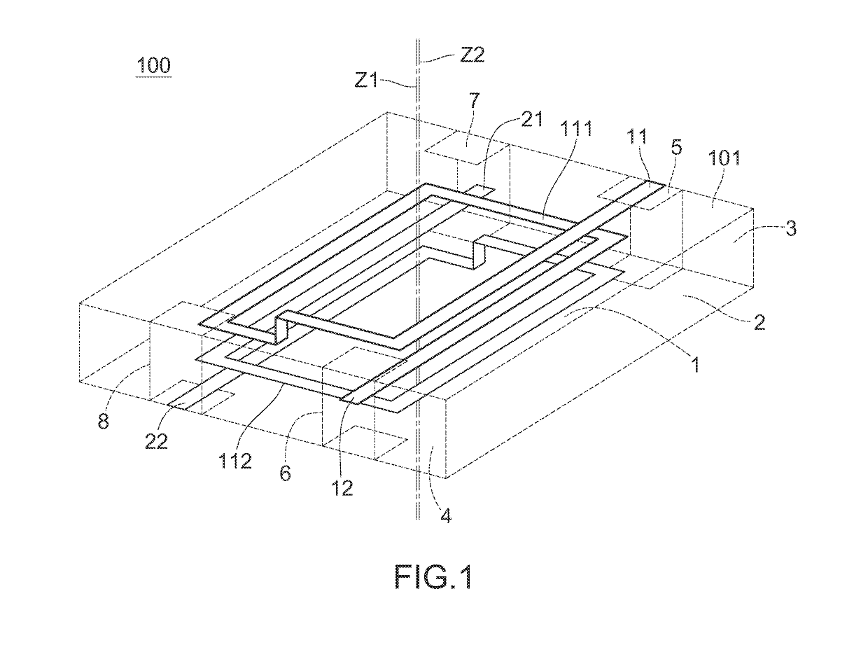

Referring to FIG. 1, which is a schematic view of a coupled inductor 100 according to one embodiment of the disclosure. This embodiment provides a coupled inductor 100, and the coupled inductor 100 comprises a magnetic core 101, a first coil 111 and a second coil 112.

As shown in FIG. 1, the magnetic core 101 has a top surface 1 and a bottom surface 2. The top surface 1 and the bottom surface 2 are opposite to each other. The first coil 111, located inside the magnetic core 101, has a first coil input end 11 and a first coil output end 12. The first coil 111 is wound around (namely, wrapped around) a first axis Z1 along a first winding direction. The first coil 111 is wound from the first coil input end 11 and is extended to the first coil output end 12. The first winding direction is a clockwise direction, and the first axis Z1 passes through the top surface 1 and the bottom surface 2. In this embodiment, the first coil 111 is completely enclosed (namely, surrounded or embedded) in the magnetic core 101. The material of the first coil 111 is silver, copper, nickel, or other metal.

The second coil 112, located inside the magnetic core 101, is separated from the first coil 111. The second coil 112 has a second coil input end 21 and a second coil output end 22. The second coil 112 is wound around a second axis Z2 in a second winding direction. The second coil 112 is wound from the second coil input end 21 and is extended to the second coil output end 22. The first winding direction is opposite to the second winding direction, so the second winding direction is a counterclockwise direction. In this embodiment, the first axis Z1 coincides with the second axis Z2, and the first axis Z1 is equal to the second axis Z2. However, for the convenience of description, the first axis Z1 and the second axis Z2 in FIG. 1 are drawn as different lines, and the first axis Z1 is made to not coincide with the second axis Z2. In addition, although the first axis coincides with the second axis in this embodiment, the disclosure is not limited thereto. In other embodiments of the disclosure, the first axis and the second axis both pass through the top surface 1 and the bottom surface 2, but do not coincide. Orthographic projections of the first coil 111 and the second coil 112 on the top surface 1 are completely overlapped (namely, superposed) with each other or partially overlapped. The orthographic projection is defined to be a projection where the projection lines are parallel and are orthogonal to the projection plane under the radiation of light from infinity, that is, the projections of the first coil 111 and the second coil 112 on the top surface 1. For example, when the first axis Z1 does not coincide with the second axis Z2, that is, when the first axis Z1 is not equal to the second axis Z2, the distance between the first axis Z1 and the second axis Z2 is less than or equal to one tenth ( 1/10) of the length or width of the top surface 1. In this embodiment, the second coil 112 is completely enclosed in the magnetic core 101. The material of the second coil 112 is silver, copper, nickel, or other metal.

As shown in the FIG. 1, the relative technical terms such as “lower” or “bottom surface”, and “upper” or “top surface” herein are used to describe a relationship between one component and another component. The technical terms herein not only comprise relative directions shown in FIG. 1, but also comprise other different directions of the coupled inductor 100. For example, if the coupled inductor 100 in FIG. 1 is turned over (upside down), the part described as the “bottom surface” above will be defined as a “top surface” part.

The coupled inductor 100 has a monolithic structure or a sintered structure. In this and some embodiments, the material of the magnetic core 101 is ferrite, or a soft magnetic material such as a nickel-copper-zinc ferrite or a nickel-magnesium-copper-zinc ferrite. The magnetic core 101 further has a first side surface 3 and a second side surface 4. The first side surface 3 and the second side surface 4 are opposite to each other. The first side surface 3 exposes a first coil input end 11 and a second coil input end 21. The second side surface 4 exposes a first coil output end 12 and a second coil output end 22. In the coupled inductor 100, the first side surface 3 is configured with a first coil input electrode 5 and a second coil input electrode 7. The second side surface 4 is configured with a first coil output electrode 6 and a second coil output electrode 8. The first coil input electrode 5 is electrically connected to the first coil input end 11, the second coil input electrode 7 is electrically connected to the second coil input end 21, the first coil output electrode 6 is electrically connected to the first coil output end 12, and the second coil output electrode 8 is electrically connected to the second coil output end 22. For example, the materials of the first coil input electrode 5, the second coil input electrode 7, the first coil output electrode 6, and the second coil output electrode 8 are silver. In a conventional inductor, the flux density is easily saturated under a high current because the magnetic field in the inductor increases. As a result, the magnetic permeability of the inductor decreases and the inductance also declines. In the structure of the coupled inductor 100 according to the disclosure, each coil generates a flux when being electrified, so two reverse (namely, opposite) magnetic fields are generated on the magnetic paths of the two coils, respectively, when a high current passes through the two coils. The first coil 111 and the second coil 112 are wound in opposite directions (clockwise and counterclockwise), so the generated and reversed fluxes are offset with each other, and the flux density is not easy to be saturated, thereby improving the inductance of the coupled inductor under a high current.

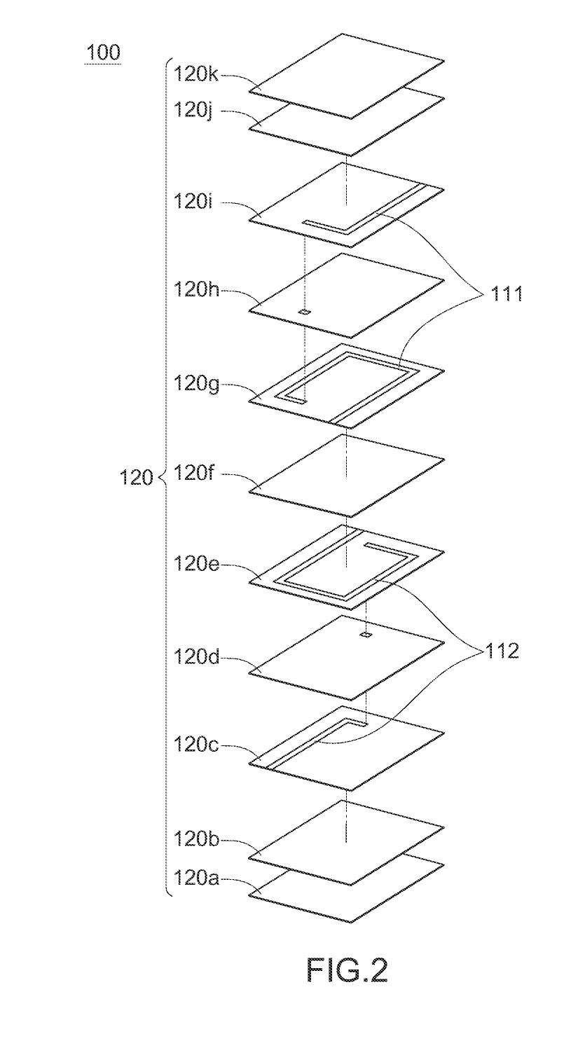

Referring to FIG. 2, which is an exploded view of a coupled inductor 100 according to one embodiment of the disclosure. The coupled inductor 100 is manufactured as follows: nickel-copper-zinc ferrite magnetic core powder and Polyvinyl Butyral (PVB) resin are mixed into slurry, and after doctor blade casting, the slurry is made into green sheets 120. The green sheets 120 are stacked top-down through lamination as shown in FIG. 2. Therefore, the stacked green sheets 120 form a magnetic core 101. FIG. 2 is described from the bottom up. First, two green sheets 120a and 120b are used as a bottom portion. A green sheet 120c is stacked in order, and a part of the green sheet 120c is hollowed, and the hollow part is corresponding to the position of a quarter (¼) part of the second coil 112. A silver paste is then filled into the hollow position through screen printing. Subsequently, a green sheet 120d with a through hole is stacked and the silver paste is then filled in to the through hole through screen printing. A green sheet 120e is further stacked, and a part of the green sheet 120e is hollowed, the hollow part is corresponding to the position of the remaining three quarters (¾) parts of the second coil 112. The silver paste in the through hole is used to electrically connect the one quarter part of the second coil 112 to the remaining three quarters part of the second coil 112. The formed lower coil (the second coil 112) is described above, and then an upper coil (the first coil 111) is stacked. A green sheet 120f is stacked between the upper coil and the lower coil so as to separate the two coils (the first coil 111 and the second coil 112). In the upper coil part, a green sheet 120g is first stacked, and a part of the green sheet 120g is hollowed, the hollow part is corresponding to the position of the three quarters parts of the first coil 111. Silver paste is then filled into the hollow position through screen printing. A green sheet 120h with a through hole is then stacked, and the silver is filled throughout the hole. A green sheet 120i is further stacked on top of the green sheet 120h, and a part of the green sheet 120i is hollowed, the hollow part is corresponding to the one quarter part of the first coil 111. The silver paste in the through hole electrically connects the one quarter part of the first coil 111 and the remaining three quarters parts of the first coil 111. Two green sheets 120j and 120k are stacked as an upper portion. After stacking through lamination, a green body is formed under hot hydrostatic pressing. The green body is then cut into coupled inductors 100. Subsequently, after the process of debindering at 450° C. and sintering at 910° C., the first coil input electrode 5, the first coil output electrode 6, the second coil input electrode 7 and the second coil output electrode 8 of the silver end are sintered at different side edges of the coupled inductor 100, so as to form the coupled inductor 100 of a monolithic structure.

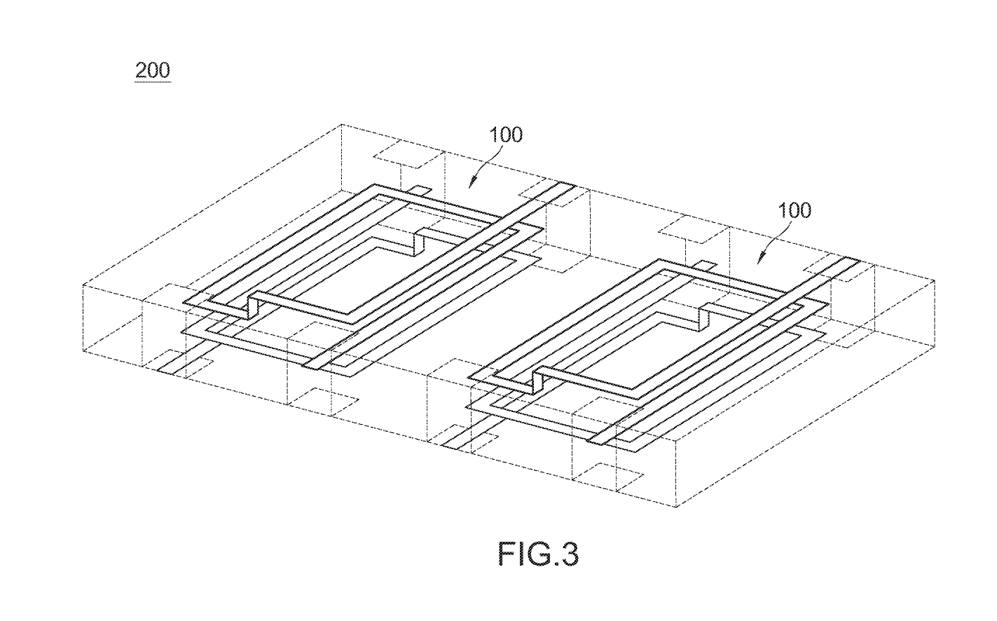

The above embodiment is not intended to limit the number of coils in the disclosure. Referring to FIG. 3, which is a schematic view of a multiphase coupled inductor 200 that has multiple pairs of coils according to the disclosure. For example, a four-phase coupled inductor 200 has two groups of coupled inductors 100. Each coupled inductor 100 is the same as that in the above embodiment, and therefore is not described herein again.

As shown in FIG. 3, the four-phase coupled inductor 200 comprises two groups of internal coils. Each group of the coils comprises a first coil 111 and a second coil 112, and the first coil 111 and a second coil 112 are separated by a ferrite. Each group of the coils is formed by stacking two vertically aligned coils. The structure of each group of the coils in the four-phase coupled inductor 200 is similar to the structure of the first coil 111 and the second coil 112 disclosed in FIG. 1, and is not described herein again. The embodiments shown in FIG. 1 and FIG. 3 are not intended to limit the orthographic projections of the first coil 111 and the second coil 112 on the top surface 1 to be completely overlapped with each other. In this and some embodiments, each group of the coils which are above mentioned is formed by stacking two coils that are vertically staggered by a small distance. That is, the two orthographic projections of the first coil 111 and the second coil 112 on the top surface 1 are partially overlapped.

### EMBODIMENTS

### First Embodiment

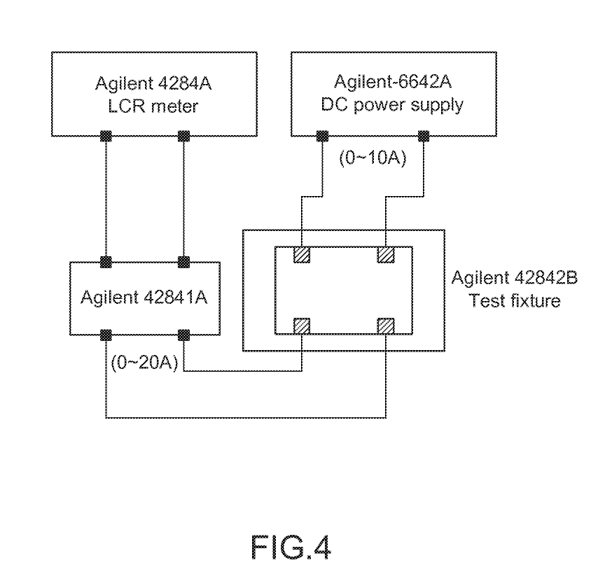

Nickel-copper-zinc ferrite powder with the magnetic permeability being 250 and PVB resin are mixed into slurry, and after doctor blade casting, the slurry is made into green sheets. Subsequently, silver wires are screen-printed on the green sheets. The winding directions of the first coil and the second coil, and the stacking structure are the same as that shown in FIG. 2, in which the first winding direction is opposite to the second winding direction. After stacking through lamination, a green body is formed under hot hydrostatic pressing. The green body is then cut into coupled inductors 100. Subsequently, after the process of debindering at 450° C. and sintering at 910° C., the coupled inductor is formed, and an input electrode and an output electrode are sintered at the side edges of each coupled inductor. The coupled inductor is the same as that shown in FIG. 1, and the exterior dimension of the coupled inductor is 12.0 millimeters (mm)×10.0 mm×2.0 mm. At the same time, a concurrent coupled inductor as a comparison embodiment of the first embodiment is made. That is, another coupled inductor, in which the winding directions of the first coil and the second coil are the same, is made through the same material, the same manufacturing method. With the schematic structural view of the inductance test under a large current as shown in FIG. 4, the inductance change under a high current of the reverse coupled inductor in the first embodiment, and that of the concurrent coupled inductor in the comparison embodiment of the first Embodiment are measured. The test results are shown in Table 1.

Referring to FIG. 4, which is a schematic view of an inductance test device 400 for a coupled inductor under a large current according to the disclosure. The Agilent-4284A is an LCR meter (Inductance (L), Capacitance (C), and Resistance (R) meter), which is cascaded with (connected in series with) an Agilent 42841A power supply. A test fixture (instrument) Agilent 42842B of the Agilent 42841A is connected to the first coil of the coupled inductor 100 so as to provide the coupled inductor 100 with a test current (from 0 to 20 amperes (A)). An Agilent-6642A is another power supply, and is connected to the second coil of the coupled inductor 100 so as to provide a test current (from 0 to 10 A). In other embodiments, the first coil and the second coil may be exchanged with each other. In this embodiment, subsequently, the two power supplies (the Agilent 42841A and the Agilent-6642A) provide currents to the two coils at the same time. For example, the inductance is measured when a current of 0 A passes through the second coil and currents from 0 to 15 A pass through the first coil; the inductance is measured when a current of 1 A passes through the second coil and currents from 0 to 15 A pass through the first coil; the inductance is measured when a current of 5 A passes through the second coil and currents from 0 to 15 A pass through the first coil; the inductance is measured when a current of 10 A passes through the second coil and the currents from 0 to 15 A pass through the first coil. Based on this method, the inductances of the coupled inductor under different currents are measured.

The test results of the reverse coupled inductor in the first embodiment and the concurrent coupled inductor in the comparison embodiment of the first embodiment are shown in Table 1, in which I₁ indicates the current that passes through the first coil, and I₂ indicates the current that passes through the second coil.

TABLE 1

| Current | | | | | | | | |
|---|---|---|---|---|---|---|---|---|
| passing | | | | | | | | |
| through | | | | | | | | |
| the first | | | | | | | | |
| coils and | | | | | Inductance of the concurrent coupled inductor | | | |
| the | Inductance of the reverse coupled inductor in | | | | in the comparison embodiment of the first | | | |
| second | the first embodiment | | | | embodiment | | | |
| coils | I₂ = 0(A) | I₂ = 1(A) | I₂ = 5(A) | I₂ = 10(A) | I₂ = 0(A) | I₂ = 1(A) | I₂ = 5(A) | I₂ = 10(A) |
| I₁ = (A) | L (μH) | L (μH) | L (μH) | L (μH) | (μH) | L (μH) | (μH) | L (μH) |
| 0 | 0.438 | 0.3036 | 0.2464 | 0.1968 | 0.436 | 0.3054 | 0.2456 | 0.1978 |
| 1 | 0.408 | 0.2964 | 0.2517 | 0.1925 | 0.405 | 0.2691 | 0.2093 | 0.1723 |
| 2 | 0.305 | 0.2508 | 0.2453 | 0.1874 | 0.304 | 0.2162 | 0.1706 | 0.1440 |
| 3 | 0.237 | 0.2040 | 0.2314 | 0.1821 | 0.237 | 0.1738 | 0.1398 | 0.1198 |
| 4 | 0.190 | 0.1673 | 0.2083 | 0.1805 | 0.189 | 0.1436 | 0.1174 | 0.1017 |
| 5 | 0.154 | 0.1396 | 0.1846 | 0.1807 | 0.155 | 0.1213 | 0.1007 | 0.0882 |
| 6 | 0.131 | 0.1200 | 0.1677 | 0.1752 | 0.131 | 0.1053 | 0.0886 | 0.0783 |
| 7 | 0.110 | 0.1036 | 0.1498 | 0.1638 | 0.110 | 0.0914 | 0.0786 | 0.0701 |
| 8 | 0.096 | 0.0902 | 0.1306 | 0.1534 | 0.095 | 0.0802 | 0.0702 | 0.0620 |
| 9 | 0.085 | 0.0796 | 0.1135 | 0.1468 | 0.083 | 0.0713 | 0.0631 | 0.0574 |
| 10 | 0.074 | 0.0706 | 0.0990 | 0.1435 | 0.073 | 0.0636 | 0.0575 | 0.0527 |
| 11 | 0.067 | 0.0631 | 0.0885 | 0.1407 | 0.067 | 0.0573 | 0.0521 | 0.0490 |
| 12 | 0.062 | 0.0568 | 0.0782 | 0.1312 | 0.060 | 0.0522 | 0.0481 | 0.0483 |
| 13 | 0.057 | 0.0517 | 0.0705 | 0.1167 | 0.056 | 0.0477 | 0.0448 | 0.0426 |
| 14 | 0.054 | 0.0475 | 0.0637 | 0.1028 | 0.054 | 0.0446 | 0.0418 | 0.0399 |
| 15 | 0.050 | 0.0441 | 0.0572 | 0.0902 | 0.050 | 0.0421 | 0.0398 | 0.0379 |

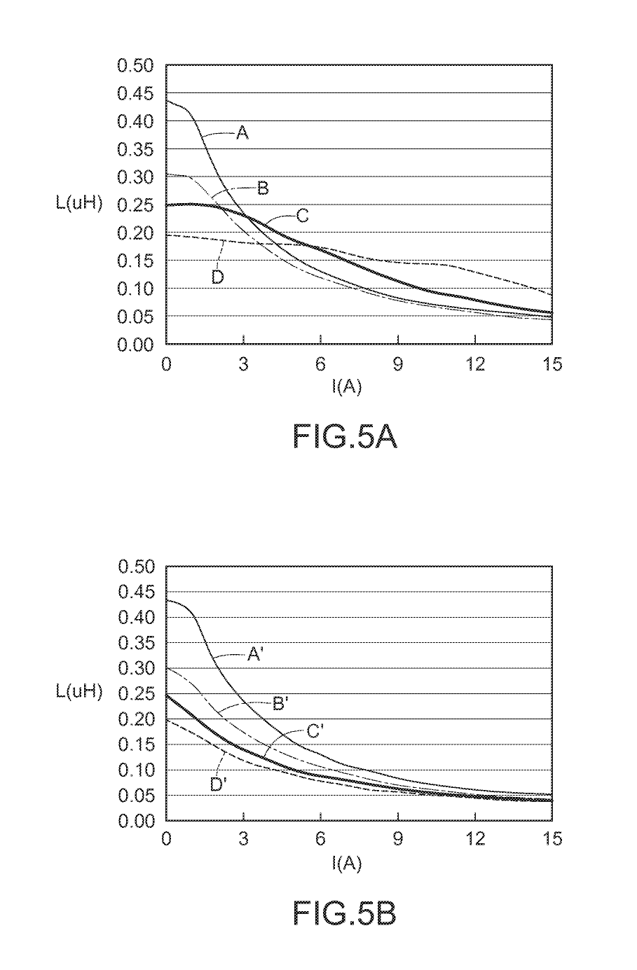

Referring to FIG. 5A and FIG. 5B, which are the test results of large-current inductance of the reverse coupled inductor 100 and the concurrent coupled inductor made of the nickel-copper-zinc ferrite magnetic core material with the magnetic permeability being 250 and through the above process according to the first embodiment of the disclosure. The test results are obtained under the test architecture shown in FIG. 4. A trend line A indicates the inductance of the coupled inductor 100 measured when no current passes through one coil, and currents from 0 to 15 A pass through the other coil. A trend line B indicates the inductance of the coupled inductor 100 measured when a current of 1 A passes through one coil, and currents from 0 to 15 A pass through the other coil. A trend line C indicates the inductance of the coupled inductor 100 measured when a current of 5 A passes through one coil, and currents from 0 to 15 A pass through the other coil. A trend line D indicates the inductance of the coupled inductor 100 measured when a current of 10 A passes through one coil, and currents from 0 to 15 A pass through the other coil. A trend line A′ indicates the inductance of the concurrent coupled inductor measured when no current passes through one coil, and currents from 0 to 15 A pass through the other coil. A trend line B′ indicates the inductance of the concurrent coupled inductor measured when a current of 1 A passes through one coil, and currents from 0 to 15 A pass through the other coil. A trend line C′ indicates the inductance of the concurrent coupled inductor measured when a current of 5 A passes through one coil, and currents from 0 to 15 A pass through the other coil. A trend line D′ indicates the inductance of the concurrent coupled inductor measured when a current of 10 A passes through one coil, and currents from 0 to 15 A pass through the other coil. According to the test results, when a current of 10 A passes through one coil of the coupled inductor 100 (namely, when I₁ is equal to 10 A in Table 1) and a current of 0 A passes through the other coil (namely, I₂ is equal to 0 A in Table 1), the inductance is 0.074 (μH), and the inductance is 0.1435 (μH) when a current of 10 A passes through the other coil (namely I₂ is equal to 10 A in Table 1). In comparison, the inductance is increased by 194% when one coil is under a current of 10 A. Besides, referring to Table 1, if the first embodiment is compared with the comparison embodiment, the test results show that when a current of 10 A passes through a coil of the reverse coupled inductor 100 in the first embodiment (namely, I₁ is equal to 10 A in Table 1), and a current of 10 A passes through the other coil of the coupled inductor 100 (namely, I₂ is equal to 10 A in Table 1), the inductance is 0.1435 (μH). In the comparison embodiment of the first embodiment, when a current of 10 A passes through a coil of the concurrent coupled inductor, and a current of 10 A passes through the other coil of the coupled inductor, the inductance is 0.0527 (μH). In comparison, the inductance is increased by 272% when a current of 10 A passes through the two coils.

### Second Embodiment

Nickel-copper-zinc ferrite powder with the magnetic permeability being 400 and PVB resin are mixed into slurry, and after doctor blade casting, the slurry is made into green sheets. Subsequently, silver wires are screen-printed on the green sheets. The first coil and the second coil are formed of silver wires. The winding directions of the first coil and the second coil, and the stacking structure are the same as that shown in FIG. 2, in which the first winding direction is opposite to the second winding direction, and the repeated are not described herein again. After stacking through lamination, the stacked structure forms a green body under hot hydrostatic pressing. The green body is then cut into coupled inductors. Subsequently, after the process of debindering at 450° C. and sintering at 910° C., the coupled inductor is formed, and an input electrode and an output electrode are sintered at the side edges of each coupled inductor, thereby forming the coupled inductor shown in FIG. 1. The exterior dimension of the coupled inductor is 12.0 mm×10.0 mm×1.9 mm. At the same time, a concurrent coupled inductor as a comparison embodiment of the second embodiment is made, that is, another coupled inductor, in which the winding directions of the first coil and the second coil are the same, is made through the same material, the same manufacturing method. With the inductance test structure under a high current shown in FIG. 4, the inductance change under a high current of the reverse coupled inductor in the second embodiment and that of the concurrent coupled inductor in the comparison embodiment of the second embodiment are measured. The test results are shown in Table 1, in which I₁ indicates the current that passes through the first coil, and I₂ indicates the current that passes through the second coil.

TABLE 2

| Current | | | | | | | | |
|---|---|---|---|---|---|---|---|---|
| passing | | | | | | | | |
| through | | | | | | | | |
| the first | | | | | | | | |
| coils and | | | | | Inductance of the concurrent coupled inductor | | | |
| the | Inductance of the coupled inductor in the | | | | in comparison embodiment of the second | | | |
| second | second embodiment | | | | embodiment | | | |
| coils | I₂ = 0(A) | I₂ = 1(A) | I₂ = 5(A) | I₂ = 10(A) | I₂ = 0(A) | I₂ = 1(A) | I₂ = 5(A) | I₂ = 10(A) |
| I₁ = (A) | L (μH) | L (μH) | L (μH) | L (μH) | L (μH) | L (μH) | L (μH) | L (μH) |
| 0 | 0.492 | 0.464 | 0.379 | 0.314 | 0.490 | 0.470 | 0.365 | 0.304 |
| 1 | 0.448 | 0.430 | 0.365 | 0.298 | 0.448 | 0.366 | 0.284 | 0.239 |
| 2 | 0.326 | 0.323 | 0.330 | 0.274 | 0.325 | 0.258 | 0.208 | 0.181 |
| 3 | 0.242 | 0.234 | 0.293 | 0.258 | 0.241 | 0.185 | 0.155 | 0.139 |
| 4 | 0.189 | 0.176 | 0.256 | 0.248 | 0.189 | 0.140 | 0.122 | 0.112 |
| 5 | 0.153 | 0.137 | 0.221 | 0.227 | 0.151 | 0.112 | 0.100 | 0.094 |
| 6 | 0.130 | 0.111 | 0.196 | 0.203 | 0.130 | 0.095 | 0.087 | 0.082 |
| 7 | 0.111 | 0.092 | 0.162 | 0.182 | 0.110 | 0.082 | 0.076 | 0.073 |
| 8 | 0.096 | 0.080 | 0.134 | 0.172 | 0.096 | 0.073 | 0.069 | 0.066 |
| 9 | 0.084 | 0.072 | 0.111 | 0.171 | 0.084 | 0.067 | 0.064 | 0.061 |
| 10 | 0.075 | 0.065 | 0.092 | 0.172 | 0.073 | 0.062 | 0.059 | 0.057 |
| 11 | 0.066 | 0.061 | 0.078 | 0.165 | 0.065 | 0.058 | 0.056 | 0.054 |
| 12 | 0.059 | 0.057 | 0.069 | 0.138 | 0.059 | 0.055 | 0.053 | 0.052 |
| 13 | 0.054 | 0.054 | 0.063 | 0.115 | 0.052 | 0.053 | 0.051 | 0.056 |
| 14 | 0.050 | 0.052 | 0.058 | 0.096 | 0.050 | 0.051 | 0.049 | 0.048 |
| 15 | 0.047 | 0.050 | 0.055 | 0.080 | 0.046 | 0.049 | 0.048 | 0.047 |

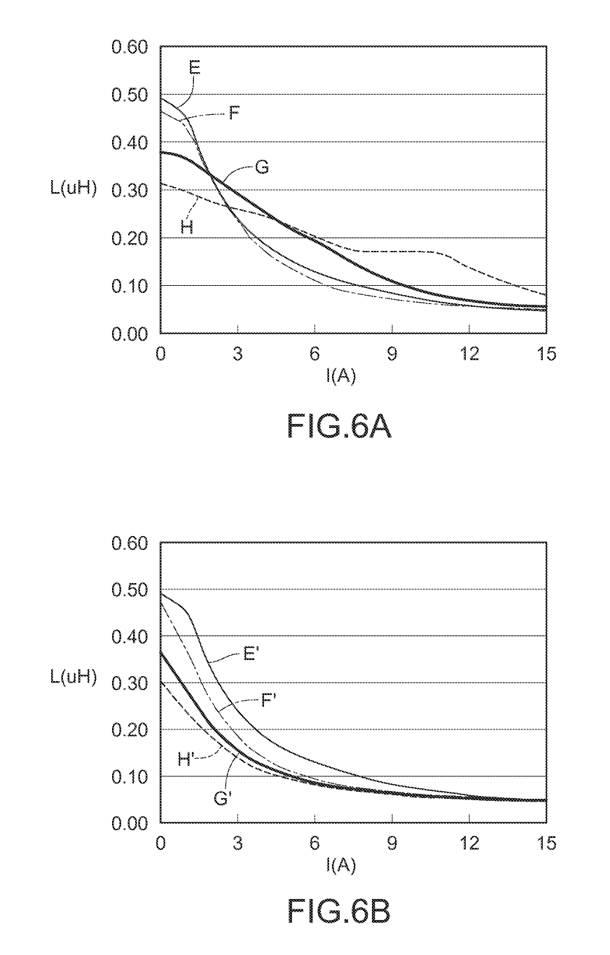

Referring to FIG. 6A and FIG. 6B, which are the test results of large-current inductance of the coupled inductor 100 made of the mixed nickel-copper-zinc ferrite magnetic core powder with the magnetic permeability being 400 and PVB resin according to the second embodiment of the disclosure. The test results are obtained under the test architecture shown in FIG. 4. A trend line E indicates the inductance of the coupled inductor 100 measured when no current passes through one coil, and currents from 0 to 15 A pass through the other coil. A trend line F indicates the inductance of the coupled inductor 100 measured when a current of 1 A passes through one coil, and currents from 0 to 15 A pass through the other coil. A trend line G indicates the inductance of the coupled inductor 100 measured when a current of 5 A passes through one coil, and currents from 0 to 15 A pass through the other coil. A trend line H indicates the inductance of the coupled inductor 100 measured when a current of 10 A passes through one coil, and currents from 0 to 15 A pass through the other coil. A trend line E′ indicates the inductance of the concurrent coupled inductor measured when no current passes through one coil, and currents from 0 to 15 A pass through the other coil. A trend line F′ indicates the inductance of the concurrent coupled inductor measured when a current of 1 A passes through one coil, and currents from 0 to 15 A pass through the other coil. A trend line G′ indicates the inductance of the concurrent coupled inductor measured when a current of 5 A passes through one coil, and currents from 0 to 15 A pass through the other coil. A trend line H′ indicates the inductance of the concurrent coupled inductor measured when a current of 10 A passes through one coil, and currents from 0 to 15 A pass through the other coil. According to the test results, when a current of 10 A passes through one coil of the coupled inductor and a current of 0 A passes through the other coil, the inductance is 0.075 (μH), and the inductance is 0.172 (μH) when a current of 10 A passes through the other coil. In comparison, the inductance is increased by 229% when one coil is under a current of 10 A. When the second embodiment is compared with the comparison embodiment, the test results show that when a current of 10 A passes through a coil of the reverse coupled inductor 100 in Embodiment 2, and a current of 10 A passes through the other coupled coil, the inductance is 0.172 (μH). In the comparison embodiment of the second embodiment, when a current of 10 A passes through a coil of the concurrent coupled inductor, and a current of 10 A passes through the other coupled coil, the inductance is 0.057 (μH). In comparison, the inductance is increased by 301% when a current of 10 A passes through each coil.

In a coupled inductor according to the disclosure, a first coil and a second coil with opposite winding directions are disposed in an upper layer and a lower layer, respectively. By means of reverse coupling of the internal magnetic path when a current passes through the first coil and the second coil, the magnetic fields are offset with each other, thereby improving the inductance of the coupled inductor under a high current.

What is claimed is:

1. A coupled inductor, comprising:
a magnetic core having a top surface and a bottom surface opposite to each other;
a first coil located in the magnetic core and having a first coil input end and a first coil output end, the first coil being wound around a first axis in a first winding direction, the first coil being wound from the first coil input end and being extended to the first coil output end, and the first axis passing through the top surface and the bottom surface; and
a second coil located in the magnetic core, separated from the first coil, and having a second coil input end and a second coil output end, the second coil being wound around a second axis in a second winding direction, the second coil being wound from the second coil input end and being extended to the second coil output end, the second axis passing through the top surface and the bottom surface, the first winding direction being opposite to the second winding direction, and an orthographic projection of the first coil on the top surface being at least partially overlapped with an orthographic projection of the second coil on the top surface.

2. The coupled inductor according to claim 1, wherein the first axis is the same as the second axis.

3. The coupled inductor according to claim 1, wherein the first axis is different from the second axis.

4. The coupled inductor according to claim 1, wherein the coupled inductor has a monolithic structure, and the first coil and the second coil are enclosed in the magnetic core.

5. The coupled inductor according to claim 4, further comprising a first coil input electrode electrically connected to the first coil input end, a first coil output electrode electrically connected to the first coil output end, a second coil input electrode electrically connected to the second coil input end, and a second coil output electrode electrically connected to the second coil output end, and wherein the first coil input electrode, the first coil output electrode, the second coil input electrode and the second coil output electrode are extended to the top surface.

6. The coupled inductor according to claim 1, wherein the materials of the first coil and the second coil are silver, copper, or nickel.

7. The coupled inductor according to claim 1, wherein the magnetic core further comprises a first side surface and a second side surface which are opposite to each other, the first side surface exposing the first coil input end and the second coil input end, and the second side surface exposing the first coil output end and the second coil output end.

8. The coupled inductor according to claim 1, wherein the orthographic projection of the first coil on the top surface is completely overlapped with the orthographic projection of the second coil on the top surface.

9. The coupled inductor according to claim 8, wherein the magnetic core is a nickel-copper-zinc ferrite or a nickel-magnesium-copper-zinc ferrite.

10. The coupled inductor according to claim 1, wherein the orthographic projection of the first coil on the top surface is partially overlapped with the orthographic projection of the second coil on the top surface.

11. The coupled inductor according to claim 1, wherein a material of the magnetic core is a soft magnetic material.
